(19) United States
(12) Patent Application Publication
(10) Pub. No.: US 2014/0051274 A1
(43) Pub. Date: Feb. 20, 2014

(54) ELECTRICAL CONNECTOR

(71) Applicant: Hon Hai Precision Industry Co., Ltd., New Taipei (TW)

(72) Inventors: CHUN-MING YU, Kunshan (CN); JI-CHAO WANG, Kunshan (CN); GUO-HUA ZHANG, Kunshan (CN); KAI-GANG YU, Kunshan (CN); QI-SHENG ZHENG, Kunshan (CN)

(73) Assignee: HON HAI PRECISION INDUSTRY CO., LTD., New Taipei (TW)

(21) Appl. No.: 13/966,306

(22) Filed: Aug. 14, 2013

(30) Foreign Application Priority Data
Aug. 14, 2012 (CN) 201220400587.1

(51) Int. Cl. H01R 13/703

(52) U.S. Cl. CPC H01R 13/7031
USPC 439/188

(57) ABSTRACT

An electrical connector comprises an insulative housing with a base portion and a tongue portion extending forwardly form the base portion. A plurality of contacts being retained in the insulative housing, and a shell surround the tongue portion to form a mating port for receiving a plug connector. A detecting contact is fixed in the insulative housing, the detecting contact has a first detecting terminal at one side of the insulative housing, the first detecting terminal has a first extending portion, a first engaging portion protruding into the mating port, a connecting part connecting with the first extending portion and the first engaging portion, the connecting part is located at the most front of the detecting contact along a front-to-back direction.

### BACKGROUND OF THE INVENTION

1. Field of the Invention

The present invention relates to an electrical connector, more particularly to an electrical connector with detecting terminals for detecting different plugs inserted therein.

2. Description of Related Art

China patent publication No. CN102082370A, published on Jun. 1, 2011, discloses a conventional electrical connector including an insulative housing, a plurality of contacts retained in the insulative housing, a shell attached to the insulative housing and a detecting contact retained in the insulative housing. The insulative housing defines a retaining slot at a right side thereof for retaining the detecting contact. The detecting contact has a retaining portion retained in the retaining slot, a soldering leg extending downwardly from one end of the retaining portion, a resilient arm extending forwardly from the retaining portion and a detecting point located at a free end of the resilient arm. However, a length of the detecting contact is too short to provide enough elasticity, as a mating plug is inserted into the electrical connector and engages with the detecting point. A long-term engagement therebetween will cause plastic deformating and the deformation can never resume.

Hence, an improved electrical connector with improved detecting contact is needed to solve the problem above.

### BRIEF SUMMARY OF THE INVENTION

An electrical connector comprises an insulative housing having a base portion and a tongue portion extending forwardly form the base portion, a plurality of contacts being retained in the insulative housing, a shell forming a mating port for receiving a plug connector, and a detecting contact fixed in the insulative housing. The detecting contact has a first detecting terminal at one side of the insulative housing, the first detecting terminal including a first extending portion, a first engaging portion protruding into the mating port, an U-shaped connecting part connecting with the first extending portion and the first engaging portion, the first extending portion and the first engaging portion are located in one side of the U-shaped connecting part along a front-to-back direction.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, refer is now made to the following descriptions taken in conjunction with the accompanying drawings, in which:

FIG. 1 is a perspective view of an electrical connector according to the present invention;

FIG. 2 is a partially exploded, perspective view of the electrical connector;

FIG. 3 is a similar view to FIG. 2, but taken from another aspect;

FIG. 4 is a view of the electrical connector with its shell removed and two detecting terminals separated from an insulactive housing;

FIG. 8 is a similar view to FIG. 7 to show a state when an USB PD (Power Deliver) plug is inserted into;

FIG. 6 is a similar view to FIG. 5, but taken from another aspect;

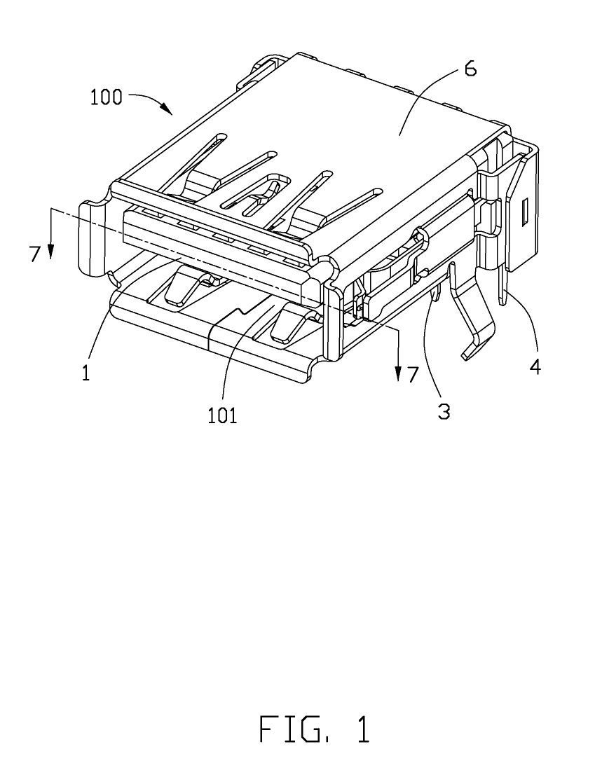

FIG. 7 is a cross-sectional view of the electrical connector taken along line 7-7 of FIG. 1;

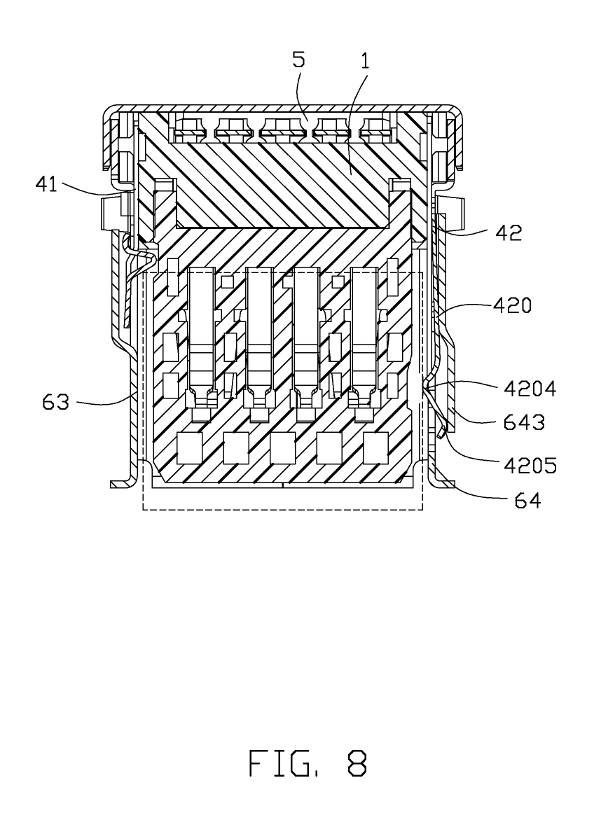

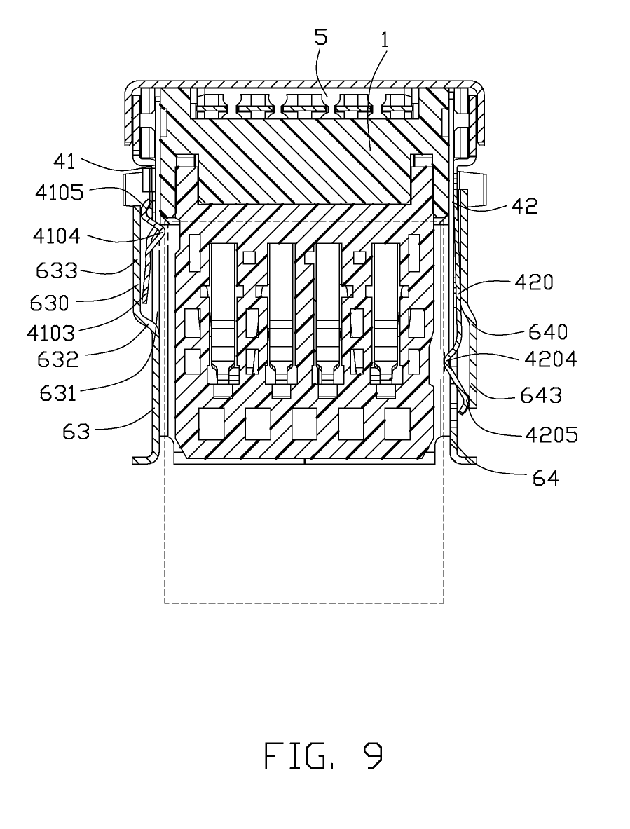

FIG. 8 is a similar view to FIG. 7 with the detecting terminal using in the USB PD (Power Deliver) plug inserted into;

FIG. 9 is a similar view to FIG. 8 but show a Standard USB plug is inserted into.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Please referring to FIGS. 1-9, an electrical connector 100 includes an insulative housing 1, a plurality of contacts 3 retained in the insulative housing 1, a spacer 5 assembled to the insulative housing, a shell 6 enclosing the insulative housing 1 and a plurality of detecting contacts 4 assembled to the insulative housing 1.

Please refer to FIGS. 1-6, the insulative housing 1 includes a base portion 10, a tongue portion 20 assembled to the base portion 10 along a front-to-back direction and the spacer 5 retained in a back side of the base portion 10. The base portion 10, the tongue portion 20 and the shell 6 form a mating port 101 (refer to FIG. 1) together for mating with a plug connector (not shown). The base portion 10 includes a main body 11 and a supporting plate 12 extending forwardly from a bottom side of the main body 11. The main body 11 has a front face 111, a rear face 112 opposite to the front face 111, a first receiving slot 1111 partly extending backwardly through the main body 11 from the front face 111 in a transverse direction, two second receiving slots 1112 extending downwardly and laterally from two sides of the first receiving slot 1111 and communicating with the first receiving slot 1111, two side portions 113 located outside of the two second receiving slots 1112, respectively, and a top portion 114 located above the first receiving slot 1111. The base portion 10 further defines a plurality of first retaining slots 1121 extending through the main body 11 and communicating with the first receiving slot 1111 and a plurality of second retaining slots 1113 sandwich between the two second receiving slots 1112.

A receiving cavity 110 is formed by the top potion 114, the rear face 112 and the two side portions 113. The side portions 113 extend beyond the rear face 112. An inner wall of the side portion 113 has a block 119, and a locking slot 118 depressing thereon and communicating with the second receiving slot 1112. The base portion 10 further has two addition portions 115 located outside of the two side portions 113, respectively. Two T-shaped slots 116 are formed between the two side portions 113 and the two addition portions 115 for positioning the detecting contacts 4, and each of the T shaped slots 116 includes a first slot 1161 extending transversely and a second slot 1162 extending vertically and communicating with the first slot 1161. Each of the T-shaped slot has a opening 1163 extending from a middle of the second slot 1162 and though the side portion 115. A length of the opening 1163 is shorter than that of the second slot 1162.

The tongue portion 20 has a plate 21 and a retaining portion 23 retained in the second receiving slot 1112. A rear end of the plate 21 is received in the first receiving slot 1111. The tongue portion 20 has a top surface 223, a bottom surface 224 opposite to the top surface 223, a mating face 225 located in a front end of the plate 21, a left side surface 226 and a right side surface 227. The plate 21 has a plurality of first receiving grooves 221 extending in a front-to-rear direction and a plurality of second receiving grooves 222 located in front of the first receiving grooves 221. The retaining portion 23 has a pair of locking arms 230 extending from a rear end thereof to lock with the locking slot 118.

The plate 21 further comprises a first notch 228 depressing from the left side surface 226 and a second notch 229 depressing from the right side surface 227. The first notch 228 is closed to the front face 111 of the base portion 10 while the second notch 229 is closed to the mating face 15 of the plate 21.

Please refer to FIGS. 5-6, the contacts 3 include a plurality of first contacts 31 and a plurality of second contacts 32 positioned in the insulative housing 1. Each of the first contacts 31 has a first connecting portion 312 received in the first receiving groove 221, a first contacting portion 313 resiliently extending into the mating port 101, a first positioning portion 314 retained in the second retaining slot 1113 and a first soldering portion 315 extending vertically from the first positioning portion 314.

The second contacts 32 are inserting-molded in the tongue portion 20. Each of the second contacts 32 includes a second positioning portion (not labeled) inserting-mold in the tongue portion 20, a second contacting portion 323 shaped as a flat piece extending from a front end of the second positioning portion and received in the second receiving groove 222, a second positioning portion 324 extending backwardly from another end of the second posting portion 324 to be received in the first retaining slot 1121 and a second soldering portion 325 extending vertically from the second positioning portion 324. The first contacting portions 313 and the second contacting portions 323 are arranged in two lines respectively along a front-to-back direction.

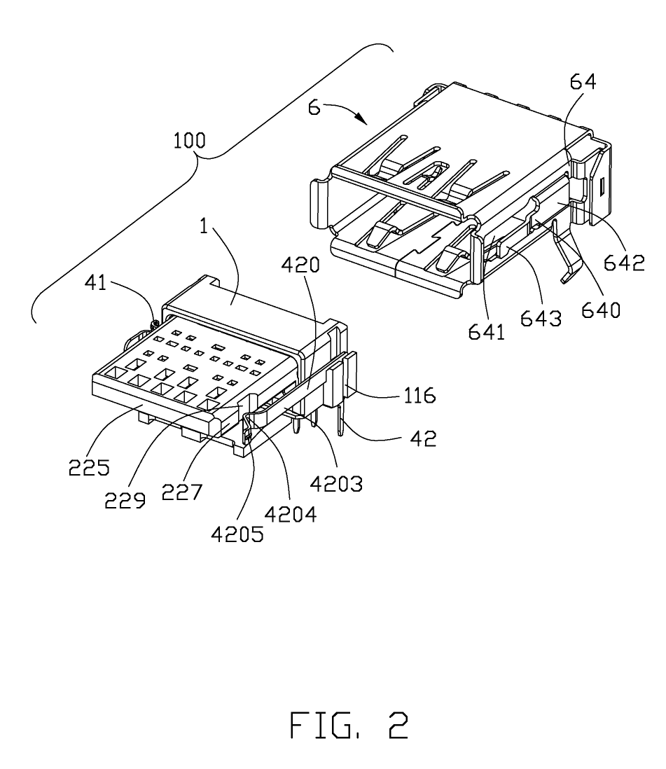

Please refer to FIGS. 2-3 and 5-6, the detecting contacts 4 include a first detecting terminal 41 retained in the T shaped slot 116 at a left side of the base portion 10 and a second detecting terminal 42 retained in the T shaped slot 116 at a right side of the base portion 10. The first detecting terminal 41 is used for detecting whether an USB PD plug for transmitting a big power of 2A is inserted into, while the second detecting terminal 42 is used for detecting whether a plug is inserted into. Refer to FIG. 5, the first detecting terminal 41 has a first horizontal portion 411 retained in the first slot 1161, a first retaining portion 412 vertically received in the second slot 1162 at the left side of the side portion 113, a first soldering leg 413 extending from the first retaining portion 412 and beyond the second slot 1162, and a first detecting arm 410 extending into the mating port 101 from the first horizontal portion 411. The second detecting terminal 42 has a second horizontal portion 421 retained in the first slot 1161, a second retaining portion 422 vertically received in the second slot 1162 at the right side of the other side portion 113, and a second soldering leg 423 extending from the second retaining portion 422 and extending downwardly beyond the second slot 1162, a second detecting arm 420 extending into the mating port 101 from the second horizontal portion 421.

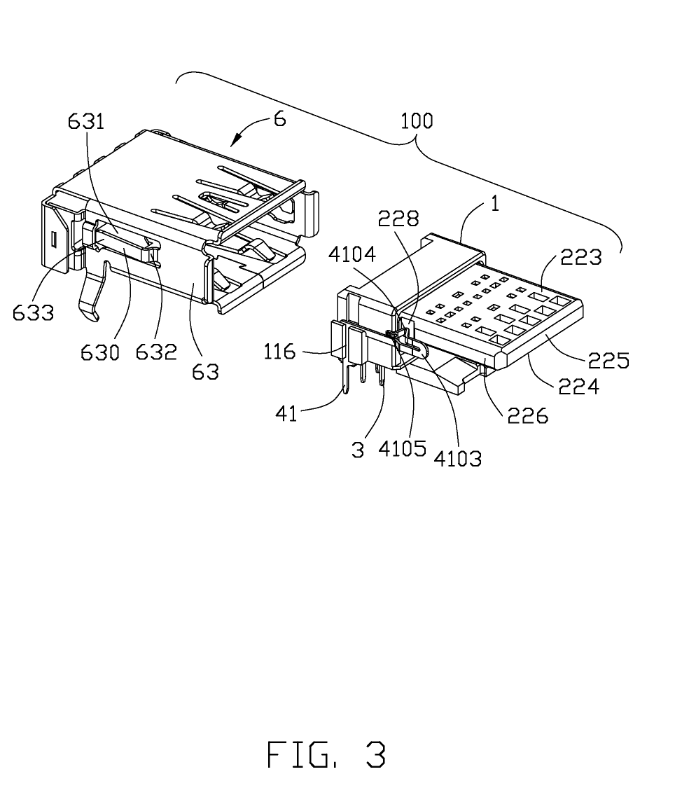

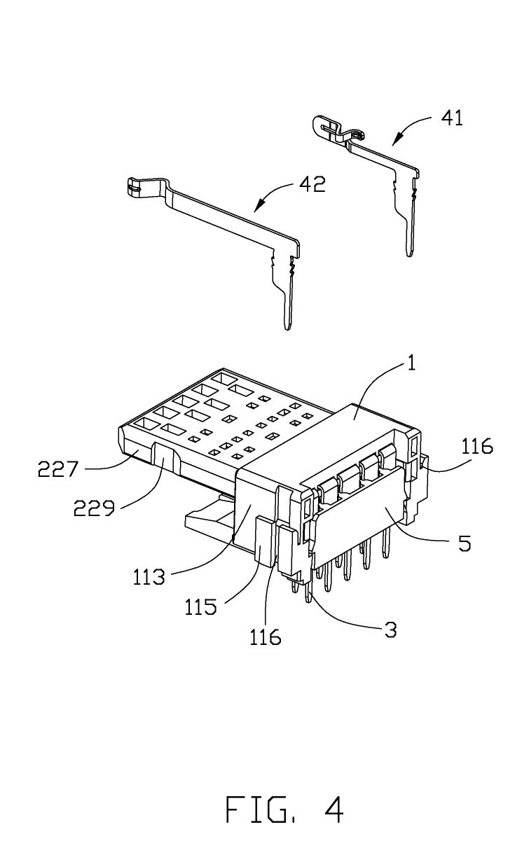

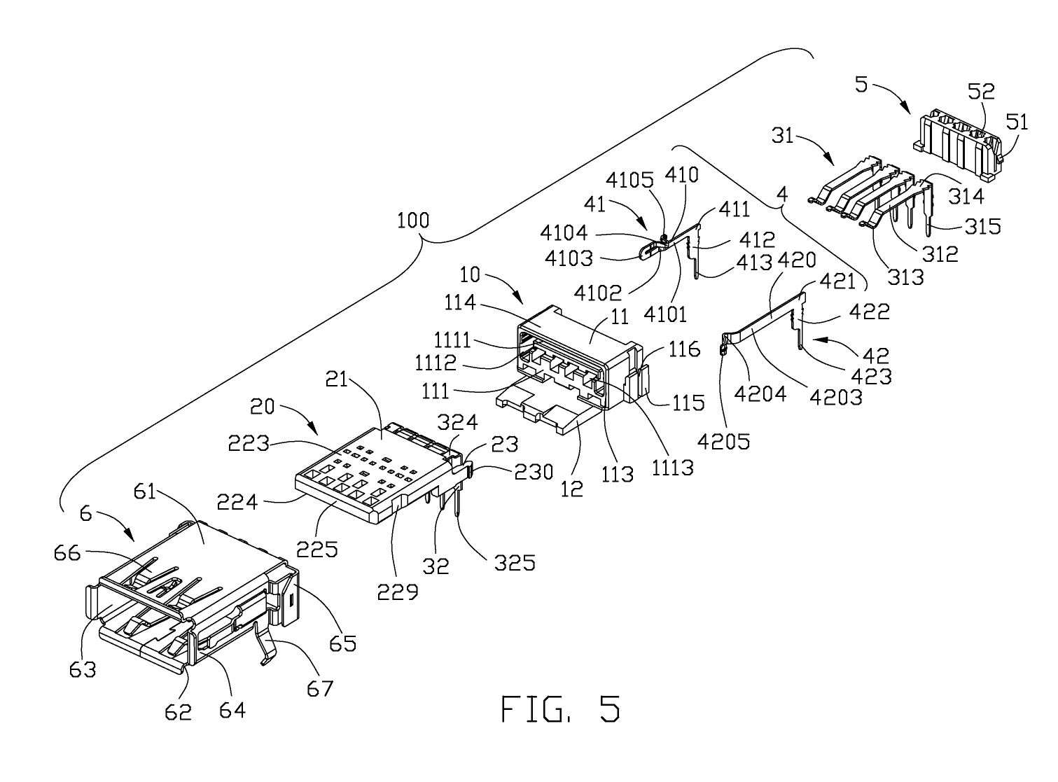

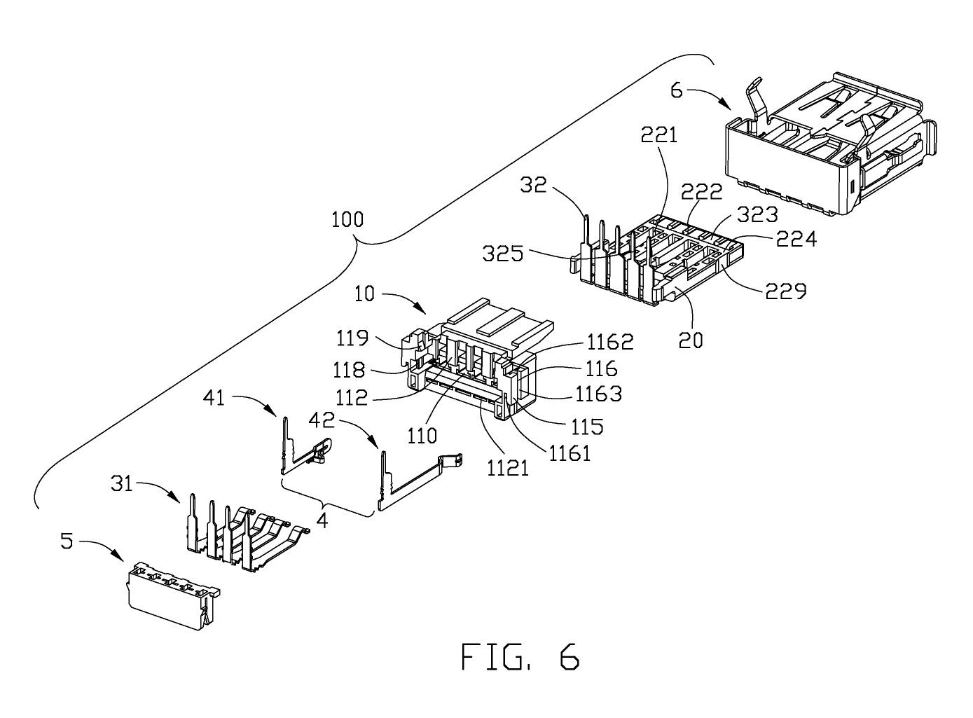

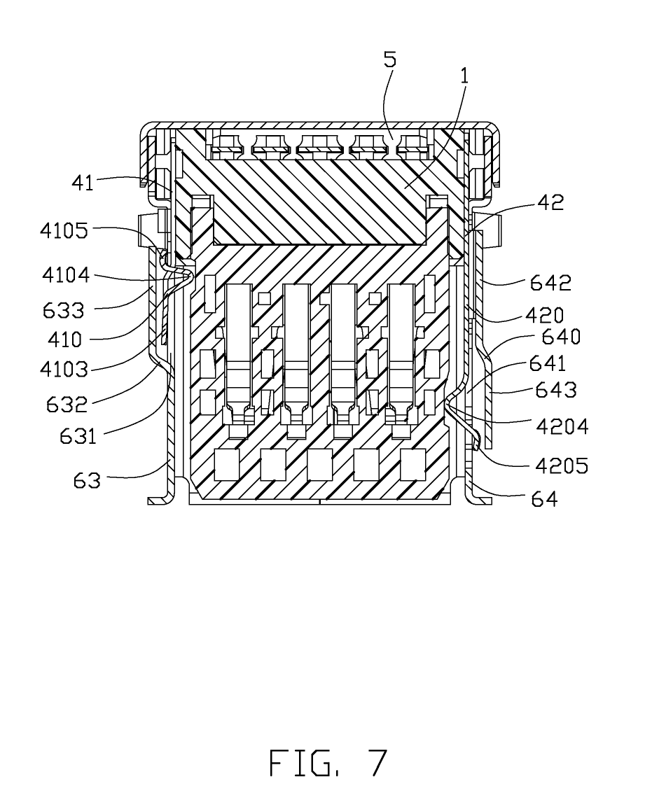

Please refer to FIG. 4, A main body of the detecting contact extends in the vertical direction. The first detecting arm 410 includes a first extending portion 4101 forwardly extending from the horizontal portion 411, a first engaging portion 4104 protruding into the mating port 101, an U-shaped connecting part 4103 disposed at a front end thereof with opposite spaced first arm and second arm (not labeled) linked by a bight (not labeled), and connecting with the first engaging portion 4104, and a first end portion 4105 extending backwardly from the first engaging portion 4104 and located at a free end thereof. The first extending portion 4101 further has an inclined portion 4102 extending forwardly and outwardly therefrom, The detecting arm 410 has the first extending portion 4101, the inclined portion 4102, the U shaped connecting part 4103, the first engaging portion 4104 and the first end portion 4105, in this arrangement, the structure of the U shaped connecting part 4103 make the detecting arm a longer length which can enhance the resilience of the first detecting arm 410. Please refer to FIGS. 3-7, the first detecting arm 410 is set vertically, the first extending portion 4101 is located outside of the base portion 10, the connecting part 4103 is located outside of the first extending portion 4101, the first engaging portion 4104 is inwardly protrudes to engage with an inner wall of the first notch 228 in a left side surface 226 of the tongue portion 20.

The second detecting arm 42 includes a second extending portion 4205 extending forwardly from the second horizontal portion 421 located outside of the mating port 101, a second engaging portion 4204 extending forwardly from the second horizontal portion 421 and protruding into the mating port 101, and a second end portion 4205 at a free end thereof. The second extending portion 4205 engages with an inner wall of the second notch 1260 at right side surface 227 of the tongue portion 20. The second extending portion 4205 is closer to the mating face 225 than the first extending portion 4101. Please refer to FIGS. 2-3, a bottom edge of the second engaging portion 4204 extends beyond the bottom surface 224 of the tongue portion 20, the first engaging portion 4104 and the first end portion 4105 are located between the top surface 223 and the bottom surface 224. Please refer to FIGS. 4-6, the spacer 5 is assembled to the receiving cavity 110 of the base portion 10 along a down-to-upper direction. The spacer 5 defines a plurality of passageways 52 for receiving the second soldering legs 325 and two islands 51 protruding outside from two side of the spacer 5 and abutting against with the block 119 to positioning the spacer 5 to the insulative housing 1.

Please refer to FIGS. 3, 5 and 6, the shell 6 has a top wall 61 located over the mating port 101, a bottom wall 62 opposite to the top wall 61, a first side wall 63 located at a left side of the tongue portion 20, a second side wall 64 located at a right side of the tongue portion 20 and a rear wall 65 bending downwardly from a rear end of the top wall 61. The first side wall 63 has a first detecting pad 630 tore from the first side wall 63 and extending beyond a plane of the first side wall located therein, a first room 631 is formed between the first detecting pad 630 and the first side wall 63 for receiving the first detecting contact 41. The second side wall 64 has a second detecting pad 640 tore from the second side wall 64 and extending beyond a plane of the second side wall located therein, a second room 641 is formed between the second detecting pad 640 and the second side wall 64 for receiving the second detecting contact 42.

The first side wall 63 further has a bridge protruding outwardly, a first additional wall extending from an end of the first side wall 63 and located outside of the first side wall 63 for covering the additional portion 115 of the base portion 10, and a retaining leg 67 extending downwardly from a bottom edge of the first side wall 63. The first additional wall is located behind the bridge. A top edge and a bottom edge of the bridge connect with the first side wall, a front edge and a rear edge of the bridge is separated from the first side wall 63, by this arrangement, the bridge can enhance the strength of the first side wall 63. The first detecting pad 630 has a bending part 632 slant outwardly of the first side wall 63, and a first extending arm 633 extending forwardly from the bending part 632. A free end of the first extending arm 633 would engage with the first engaging portion 4104 as a plug is inserted into the electrical connector 100. An outside surface of the first extending arm 633 is copular with an outside surface of the bridge. Partly of the second side wall 64 at a rear end protrudes outside of the second side wall 64 to form an emboss 642, and the second detecting pad 640 extends forwardly from a front middle end of the emboss 642 and has a second extending arm 643, the second side wall 64 further has a second additional wall covering over the additional portion 115 of the right side portion 113. A free end of second extending arm 643 would engage with the second end portion 4205 of the second detecting terminal 42. The top wall 61 and the bottom wall 62 have a plurality of fingers 66 for positioning the plug.

Please refer to FIGS. 7-9, FIG. 7 and FIG. 9 show different plugs are inserted into the electrical connector 100. As showing in FIG. 7, in original state, the first and second end portion 4105, 4205 do not connect with the shell 6. As shown in FIG. 8, when the USB PD plug with a longer mating body is inserted into the electrical connector 100, the mating body of the plug presses the first and second detecting terminals 41, 42 respectively, then the first engaging portion 4104 and the second engaging portion 4204 move outside and make the first and second end portions 4105, 4205 connect with the first and second contacting points 3311, 344 respectively. As an Thin Card (not shown) is inserted into the electrical connector 100, although the Thin Card has a longer body and can reach the back end of the mating port 101, but the Thin Card has a thin body which just needs a bottom side part of the mating port under the tongue portion 20, the first engaging portion 4104 of the first detecting terminal 41 does not extend beyond the bottom surface 224 of the tongue portion 20, so the Thin Card just can engage with the second engaging portion 4204 of the second detecting terminal 42 and make the second end portion 4205 move outside and connect with the second contacting point 344. As shown in FIG. 9, when the standard USB plug is inserted into the electrical connector 100, for the standard USB has a shorter mating body that can not reach the end of the mating port 101, so the USB plug can not engage with the first detecting terminal 41 and just can engage with the second engaging portion 4204 of the second detecting terminal 42, the second end portion 4205 would move outside and touch with the second contacting point 344.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

We claim:

1. An electrical connector comprising:
an insulative housing having a base portion and a tongue portion extending forwardly form the base portion;
a plurality of contacts retained in the insulative housing;
a shell surrounding the tongue portion to form a mating port for receiving a plug; and
a first detecting terminal fixed to a side of the insulative housing, the first detecting terminal including a first extending portion extending forwardly beside the tongue portion, a first engaging portion protruding into the mating port and located upon the first extending portion, an U-shaped connecting part connecting with the first extending portion and the first engaging portion, and located at the most front of the first detecting terminal along a front-to-back direction.

2. The electrical connector as claimed in claim 1, wherein the tongue portion has a left side surface at a left side thereof, a right side surface at a right side thereof, a top surface, a bottom surface opposite to the top surface and a mating face at a front end thereof, the contacts have a plurality of contacting portions exposed in the bottom surface of the tongue portion, a bottom edge of the first engaging portion does not extend beyond the bottom surface along a vertical direction.

3. The electrical connector as claimed in claim 2, wherein the tongue portion further has a first notch depressing from the left side surface, and the first engaging portion is received in the first notch.

4. The electrical connector as claimed in claim 2, wherein the first detecting terminal has a first end portion extending backwardly from the first engaging portion and near to the shell, the first extending portion has an inclined portion extending outwardly, one end of the U-shaped connecting part connects with the inclined portion.

5. The electrical connector as claimed in claim 4, further comprises a second detecting terminal retained in another side of the insulative housing, the second detecting terminal has a second extending portion, a second engaging portion extending forwardly from the second extending portion and a second end portion located at a free end thereof, the second engaging portion is much closed to the mating face than that of the first engaging portion.

6. The electrical connector as claimed in claim 5, wherein the tongue portion further has a second notch depressing from the right side surface, the second engaging portion is received in the second notch.

7. The electrical connector as claimed in claim 5, wherein the base portion further comprises a pair of side portions located at two sides thereof and two additional portions located outside of the two side portions respectively, two T-shaped slots are formed between the two side portions and the two addition portions respectively for positioning the detecting contacts.

8. The electrical connector as claimed in claim 7, wherein each of the T-shaped slots includes a first slot extending transversely, a second slot extending vertically and communicating with the first slot, the first detecting terminal and the second detecting terminal each define a horizontal portion retained in corresponding first slot and a retaining portion vertically received in corresponding second slot.

9. The electrical connector as claimed in claim 5, wherein a bottom edge of the second engaging portion extends beyond the bottom surface of the tongue portion along vertical direction.

10. The electrical connector as claimed in claim 5, wherein both the first detecting terminal and the second detecting terminal are all located inside of the shell.

11. The electrical connector as claimed in claim 10, wherein the shell has two side walls located at two sides of the mating port, at least one of the side walls is formed with a detecting pad corresponding to the detecting contact.

12. An electrical connector comprising:
an insulative housing having a base portion and a tongue portion extending forwardly form the base portion;
a plurality of contacts retained in the insulative housing;
a shell surrounding the tongue portion and having two side walls located at two sides of the tongue portion, one side wall formed a first detecting pad extending backwardly along a front-to-back direction; and
a detecting terminal retained in a side of the insulative housing and located corresponding to the detecting pad, respectively, the detecting terminal having a detecting arm extending forwardly but located inside of the detecting pad; wherein
the detecting terminal including a first extending portion, a first engaging portion protruding into the mating port, a connecting part having two ends connecting with the first extending portion and the first engaging portion, respectively, the connecting part is located at the most front of the detecting terminal along a front-to-back direction.

13. The electrical connector as claimed in claim 12, wherein the tongue portion has a top surface and a bottom surface opposite to the top surface, two side surfaces connecting with the top and bottom surfaces along a top-to-bottom direction and a mating face at a free end thereof.

14. The electrical connector as claimed in claim 13, wherein the tongue portion further comprises two notches depressing from two side surfaces thereof, one is closed to the mating face of the tongue and the other is closed to a front face of the base portion.

15. An electrical connector comprising:
an insulative housing including a base portion with a mating tongue extending forward thereform in a front-to-back direction;
a plurality of contacts disposed in the housing with contacting sections exposed upon the mating tongue;
a metallic shell securely enclosing said housing and including opposite top and bottom walls in a vertical direction perpendicular to said front-to-back direction, and two opposite side walls in a transverse direction perpendicular to both said front-to-back direction and said vertical direction, wherein said top wall, said bottom wall, and said two opposite side walls commonly define a receiving cavity into which said mating tongue with the corresponding contacting sections extend;
a detecting contact disposed in the housing with a detecting arm extending into the receiving cavity with an U-shaped structure at a distal end, said U-shaped structure defining a first arm and a second arm spaced from each other while being linked by a bight under a condition that the first arm is linked to the detecting arm, and an inwardly protruding engaging portion is formed on the second arm; wherein
the inwardly protruding engaging portion is positioned in a path of a metallic shield of a plug which is adapted to be inserted into the receiving cavity, so as to have said detect arm outwardly deflected.

16. The electrical connector as claimed in claim 15, wherein said second arm is further equipped with an end portion adapted to contact one of said top wall, said bottom wall and said two opposite side walls, when the plug is inserted into the receiving cavity.

17. The electrical connector as claimed in claim 16, wherein said one of said top wall, said bottom wall and said two opposite side walls is the side wall, and defines a resilient detecting pad for contacting the detecting contact when said plug is inserted into the receiving cavity.

18. The electrical connector as claimed in claim 15, wherein said detecting contact is located beside one of said side walls and deflected in said transverse direction.
